(19) United States
(12) Patent Application Publication
(10) Pub. No.: US 2014/0310458 A1
(43) Pub. Date: Oct. 16, 2014

(54) DATA TRANSFERRING METHOD AND APPARATUS AND STORAGE SYSTEM

(71) Applicant: Tencent Technology (Shenzhen) Company Limited, Shenzhen City (CN)

(72) Inventors: Lipeng XIAO, Shenzhen City (CN); Lifang ZHANG, Shenzhen City (CN); Kaiyuan ZENG, Shenzhen City (CN); Chaoyu ZHONG, Shenzhen City (CN); Sihua ZHUANG, Shenzhen City (CN)

(73) Assignee: Tencent Technology (Shenzhen) Company Limited, Shenzhen City (CN)

(21) Appl. No.: 14/259,133

(22) Filed: Apr. 22, 2014

Related U.S. Application Data
(63) Continuation of application No. PCT/CN2013/088866, filed on Dec. 9, 2013.

(30) Foreign Application Priority Data
Apr. 11, 2013 (CN) 201310125039.1

(51) Int. Cl. G06F 3/06

(52) U.S. Cl. CPC G06F 3/0626; G06F 3/0689; G06F 3/0652
USPC 711/114

(57) ABSTRACT

A data transferring method, apparatus and storage system is provided. The method includes: acquiring, by an access device, data of a first storage device; transferring, by the access device, the acquired data of the first storage device to a second storage device; performing, by the access device upon receiving a service request during transferring of the data, the service request carrying at least parameter name and operation method of an object to be accessed, corresponding service operations on the first and/or second storage device according to the parameter name and the operation method of the object to be accessed. Data transferring between the first and the second storage device and normal processing of service for outside is achieved through the access device, and thereby step of adding underlayer protocols for achieving access between storage devices is not needed and problem of requiring multiple developments can be avoided.

### CROSS REFERENCE TO RELATED APPLICATIONS

The application is a U.S. continuation application of International Application PCT/CN2013/088866 with an international filing date of Dec. 9, 2013, which claims the priority benefit of Chinese Patent Application No. 201310125039.1 filed on Apr. 11, 2013, the contents of which are both being incorporated by reference herein in their entireties for all intended purposes.

### FIELD OF THE INVENTION

The present invention relates to the field of terminal devices, and in particular, to data transferring method, apparatus and storage system.

### BACKGROUND

With developments in computer technology, amount of data that needs to be processed by a storage system become larger and larger. For extending storage capacity of the storage system, many types of storage devices can be selected and used therein for storing data. However, different storage devices use different underlayer protocols, which causes requirement of considering underlayer protocols of the storage devices, service condition of the source storage device for transferring data or the like during data transferring between these storage devices.

Conventionally, during data transferring, a destination storage device adds underlayer protocol of a source storage device, and switches service of the source storage device to the destination storage device such that the destination storage device can directly access the source storage device during data transferring, and meanwhile, data in the source storage device is transferred to the destination storage device by a third-party tool.

In implementation of the above mentioned technology, some problems exist. For example, during data transferring, the destination storage device directly accesses the source storage device, which requires addition of underlayer protocol of the source storage device in the destination storage device, and thus system complexity is increased. Further, the third-party tool needs to support all of underlayer protocols. For example, if there is N underlayer protocols, the third-party tool should support N*(N-1) underlayer protocols. Thus, at each time when the storage system performs data transferring with the third-party tool, the third-party tool should be further developed by taking system evolution into consideration, which causes additional cost and complexity for the data transferring.

### SUMMARY OF THE INVENTION

According to various embodiments, a data transferring method, apparatus and storage system is provided, the detailed contents of which are listed as below.

In one aspect, a data transferring method is provided. The method is performed in a data storage system which includes an access device and at least two storage devices, the at least two storage devices including a first storage device and a second storage device. The method includes:

acquiring, by the access device, data of the first storage device, the first storage device being source storage device for transferring;

transferring, by the access device, the acquired data of the first storage device to the second storage device, the second storage device being destination storage device for the transferring; and

performing, by the access device upon receiving a service request during transferring of the data, the service request carrying at least parameter name and operation method of an object to be accessed, corresponding service operations on the first storage device and/or the second storage device according to the parameter name and the operation method of the object to be accessed.

In another aspect, a data transferring apparatus is provided. The data transferring apparatus includes:

an acquiring module configured to acquire data of the first storage device, the first storage device being source storage device for transferring;

a transferring module configured to transfer the acquired data of the first storage device to the second storage device, the second storage device being destination storage device for the transferring; and

a service operating module configured to perform, upon receiving a service request during transferring of the data, the service request carrying at least parameter name and operation method of an object to be accessed, corresponding service operations on the first storage device and/or the second storage device according to the parameter name and the operation method of the object to be accessed.

In another aspect, a storage system is provided. The storage system includes an access device and at least storage devices, the at least storage devices including a first storage device and a second storage device, the access device is configured to:

acquiring, by the access device, data of the first storage device, the first storage device being source storage device for transferring;

transferring, by the access device, the acquired data of the first storage device to the second storage device, the second storage device being destination storage device for the transferring; and

performing, by the access device upon receiving a service request during transferring of the data, the service request carrying at least parameter name and operation method of an object to be accessed, corresponding service operations on the first storage device and/or the second storage device according to the parameter name and the operation method of the object to be accessed.

In another aspect, a computer readable storage medium storing computer executable instructions for controlling a computer to execute the data transferring method is provided.

According to technical solutions in the embodiments of the present invention, many advantages can be obtained. For example, with the data transferring method, apparatus and storage system in which acquiring, by an access device, data of a first storage device; transferring, by the access device, the acquired data of the first storage device to a second storage device; performing, by the access device upon receiving a service request during transferring of the data, the service request carrying at least parameter name and operation method of an object to be accessed, corresponding service operations on the first storage device and/or the second storage device according to the parameter name and the operation method of the object to be accessed, data transferring between the first storage device and the second storage device and normal processing of service for outside is achieved through the access device, and thereby step of adding underlayer protocols for achieving access between storage devices is not needed and problem of requiring multiple developments because need of consideration of different types of protocols between storage devices when a third-party tool conducts the data transferring can be avoided, and thereby cost for data transferring can be reduced and complexity of system also can be reduced.

### DESCRIPTION OF THE DRAWINGS

In order for clearly describing technical solutions of the embodiments of the present invention, some figures assisting to describe the embodiments are listed. Obviously, these figures illustrate only some embodiments of the present invention and other figures may be obtained without additional inventive efforts of a person skilled in the art.

FIG. 1 is a flow diagram showing a data transferring method according to an embodiment of the present invention;

FIG. 2 is a flow diagram showing a data transferring method according to an embodiment of the present invention;

FIG. 3 is a figure illustrating structure of a data transferring apparatus according to an embodiment of the present invention;

FIG. 4 is a figure illustrating structure of a storage system according to an embodiment of the present invention; and

FIG. 5 is a figure illustrating structure of a storage system according to an embodiment of the present invention.

### DETAILED DESCRIPTION

In order for clearness of purpose, technical solutions of the present invention and its advantages, various embodiments of the present invention will be described in detail by reference to the figures.

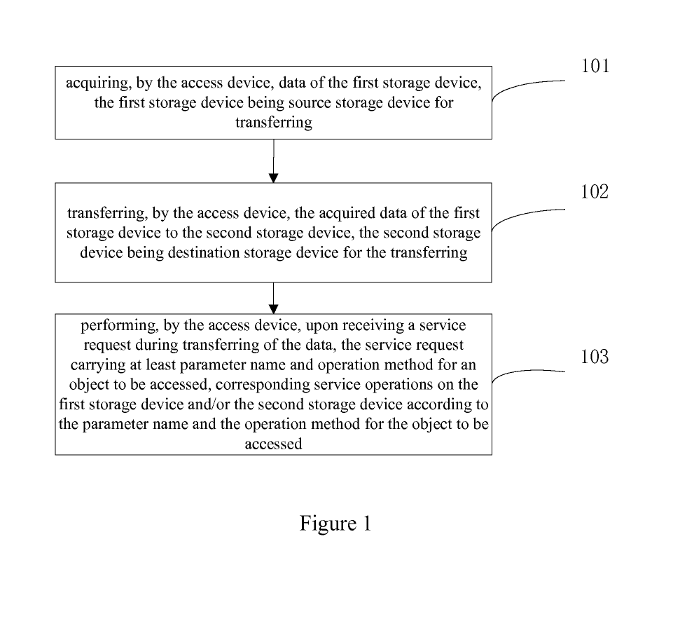

FIG. 1 is a flow diagram showing a data transferring method according to an embodiment of the present invention. The data transferring method is performed in a data storage system which includes an access device and at least two storage devices, the at least two storage devices including a first storage device and a second storage device. The method in this embodiment is carried out by the access device.

The “access device”, as used herein, has a function of processing data in each of the storage devices within the storage system, such as reading data, writing data, updating data, deleting data and the like, and the embodiments are not limited thereto. In order for the access device to achieve the processing of data in each of the storage devices within the storage system, the access device requires addition of underlayer protocols of each of the storage device, and each of the storage devices requires addition of the underlayer protocol of the access device in order for access with each other.

The “access device”, as used herein, may be a server that is suitable for any platform related to a data storage system, and is configured to provide certain server functionalities such as the data transferring function disclosed herein. The “access device”, as used herein, may be a single serve or includes multiple server modules that cooperate to implement the above mentioned functionalities. The server or server modules may include one or more processors for carrying out computer program corresponding to the method disclosed herein.

In one embodiment, the access device may be a CCNS (cloud common nosql service) access device, which provides a platform unrelated to storage medium. Nosql means a non-relational database. As compared with other types of access device, the CCNS access device, for a storage system having N protocols, needs to support only N protocols,

The “storage device”, as used herein, is a storage medium or means for storing data, including but being not limited to common storage medium (for example, magnetic storage medium, optical storage medium, magneto-optical storage medium) and cloud storage platform, and the like). For example, the “storage device”, as used herein, may be solid hard disk (SSD) storage device. Further, the storage devices used herein are called as a first storage device and a second storage device, but these storage devices may be the same or different type of storage devices. Further, two storage devices are disclosed in the embodiments, but more storages may be included.

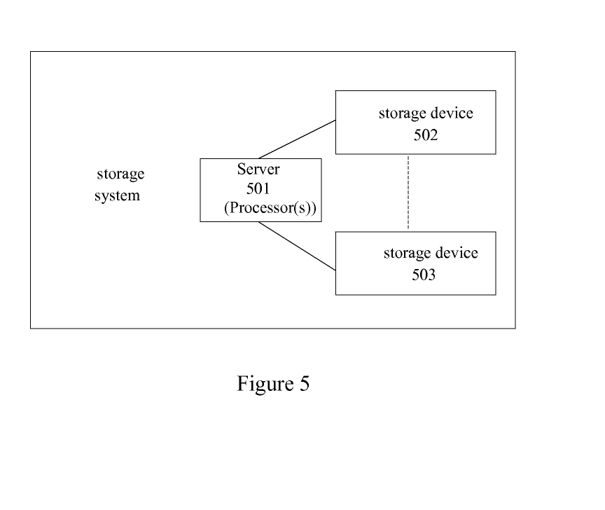

The “data storage system”, as used herein, may be any system that includes a processor and storage devices, the processor being able to perform data transferring between the storage devices. FIG. 5 shows an exemplary data storage system 501 that includes a processor 501 and two storage devices 502 and 503, wherein the processor 501 is able to perform data transferring between the storage devices 502 and 503.

In one embodiment, the disclosure can implement data transferring between a hot storage device and a cold storage device. The cold storage device is used for storing data that is not usually used, while the hot storage device is used for storing data that is usually used. Generally, the hot storage device has a higher storage level than a cold storage device. The storage level may indicate priority of data being stored or length of time interval of data being accessed.

In an embodiment, during data transferring, the CCNS access device can quickly transfer data stored in the cold or hot storage device in an activating or sinking manner among those storage devices. When the access device transfers data stored in a hot storage device to a cold storage device, a procedure of data sinking of the hot storage device is involved, and when the access device transfers data in a cold storage device to a hot storage device, a procedure of data activating is involved.

The data transferring method provided by the embodiments of the present disclosure is described in detail by reference to the FIG. 1. As shown in FIG. 1, the method includes:

step 101: acquiring, by the access device, data of the first storage device, the first storage device being source storage device for transferring;

The access device has a function of processing data in each of the storage devices within the storage system, such as reading data, writing data, updating data, deleting data and the like, and the embodiments are not limited thereto. In order for the access device to achieve the processing of data in each of the storage devices within the storage system, the access device requires addition of underlayer protocols of each of the storage device, and each of the storage devices requires addition of the underlayer protocol of the access device in order for access with each other.

Preferably, the access device may be a CCNS (cloud common nosql service) access device, which provides a platform unrelated to storage medium. Nosql means a non-relational database. As compared with other types of access device, the CCNS access device, in a storage system having N protocols, needs to support only N protocols, and for data transferring, it can quickly transfer data in each of storage devices in an activating or sinking manner among the storage devices. When the access device transfers data in a hot storage device to a cold storage device, a procedure of data sinking of the hot storage device is involved, and when the access device transfers data in a cold storage device to a hot storage device, a procedure of data activating is involved.

In the data storage system, when data in the first storage device should be transferred to another storage device due to some reasons such as capacity reduction, termination of operation, drawing out thereof, the access device sends a data reading request to the first storage device such that the first storage device transmits data stored therein to the access device and thus the access device acquires the data from the first storage device.

step 102: transferring, by the access device, the acquired data of the first storage device to the second storage device, the second storage device being destination storage device for the transferring;

upon receiving data from the first storage device, the access device send the data from the first storage device to the second storage device such that the second storage device receives and stores the data from the first storage device.

When the amount of data from the first storage device is relatively larger, the access device will take more time to transfer the data from the first storage device to the second storage device. In this case, service for outside should be considered. When the amount of data from the first storage device is relatively smaller, the access device will take litter time to transfer the data from the first storage device to the second storage device.

Preferably, in practical application, transferring of data within the storage system to the second storage device may be done via a set command.

step 103: performing, by the access device upon receiving a service request during transferring of the data, the service request carrying at least parameter name and operation method of an object to be accessed, corresponding service operations on the first storage device and/or the second storage device according to the parameter name and the operation method of the object to be accessed.

In the storage system, data may be stored in at least one storage device and may be stored with a parameter name or particular digital number. The parameter name is used for identifying the data, and may be an ID number of the data, characteristic number of the data, and the like. The present invention is not limited to these. Preferably, the parameter name or particular digital number may be a key-value.

When a user accesses data in a storage device, the data may be considered as the object to be accessed and the object to be accessed may correspond to one or more data in the storage device. A service request may carry at least parameter name of an object to be accessed. When such service request is received by the storage device, matching is done using the parameter name with data stored in the storage device, and the data corresponding to the parameter name is acquired and sent to the user.

During data transferring, in order to ensure normal operation of service for outside, the access device receives and processes the service request from outside. Particularly, upon receiving the service request, the access device acquires the parameter name and the operation method of an object to be accessed from the service request. When the operation method is not a writing operation, the access device does matching in the first storage device and/or the second storage device, acquires corresponding data and then processes the data according to the operation method.

In detail, when the operation method is a reading operation, the access device, according to the parameter name of the object to be accessed carried in the service request, does matching in the first storage device firstly. If there is no corresponding data in the first storage device, the access device does matching in the second storage device so as to acquire data corresponding to the parameter name of the object to be accessed carried in the service request. Of course, the access device may also does matching in the second storage device firstly, and if there is no corresponding data in the second storage device, then does matching in the first storage device so as to acquire data corresponding to the parameter name of the object to be accessed carried in the service request. In a storage system with various proprieties for storage devices, matching is firstly done in a storage device having higher priority and if there is not corresponding data in the storage device having higher priority, then matching is done in a storage device having lower priority so as to acquire data corresponding to the parameter name of the object to be accessed carried in the service request. These contents are described by taking reading operation as an example, for other operation method such updating, deleting and the like, the operation procedure basically is the same and thus is omitted.

It should be noted that when the operation method is a writing operation, the service request must carry data to be written, and thus the access device writes the data and its parameter name to the first storage device or the second storage device. If the first storage device and the second storage device do not have priority levels, the access device writes the data to the destination storage device, i.e. to the second storage device, and If the first storage device and the second storage device have priority levels, the access device writes the data to the storage device having higher priority, and in a case where the first storage device has higher priority than the second storage device, to the first storage device.

With the data transferring method in which acquiring, by an access device, data of a first storage device; transferring, by the access device, the acquired data of the first storage device to a second storage device; performing, by the access device upon receiving a service request during transferring of the data, the service request carrying at least parameter name and operation method of an object to be accessed, corresponding service operations on the first storage device and/or the second storage device according to the parameter name and the operation method of the object to be accessed, data transferring between the first storage device and the second storage device and normal processing of service for outside is achieved through the access device, and thereby step of adding underlayer protocols for achieving access between storage devices is not needed and problem of requiring multiple developments because need of consideration of different types of protocols between storage devices when a third-party tool conducts the data transferring can be avoided, and thereby cost for data transferring can be reduced and complexity of system also can be reduced.

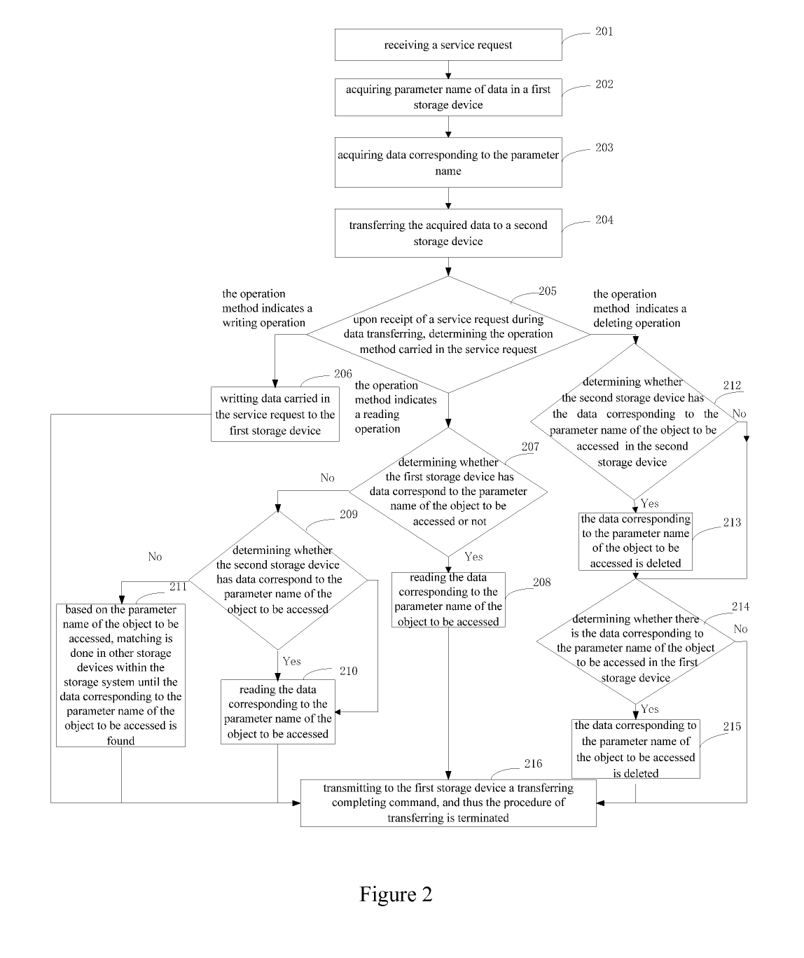

FIG. 2 is a flow diagram showing a data transferring method according to an embodiment of the present invention. The method also is performed by the access device. As shown in FIG. 2, the method includes:

step 201: the access device receives a service request;

Optionally, the access device receives a service request for data in the first storage device that is sent from the first storage device; or the access device receives a service request for data in the second storage device that is sent from the second storage device. Before data transferring, if the first storage device receives the service request, the service request is switched from the first storage device to the access device, and if the second storage device receives the service request, the service request is switched from the second storage device to the access device. That is, if any one of the first and second storage devices receives a service request, the service request is transmitted from the one to the access device in order to ensure that the service will not affected by data transferring between the first storage device and the second storage device. Upon receiving the service request, the access device, according to information carried in the service request, performs corresponding functional operations. For example, if only the first storage device receives a service request, the first storage device switches the service request to the access device.

It should be noted that the step 201 is an optional step. If the access device itself is responsible for services for outside, the first storage device and the second storage device do not directly receive any service request, but the access device receives the service request and performs processes on data stored in the storage devices according to information carried in the service request so as to implement the service for outside.

step 202: the access device acquires parameter name of data in the first storage device;

the access device acquires parameter name of data in the first storage device by using a data scheduling system. The data scheduling system may be a functional module of the storage system, may be a system separating from the storage system, and may be a functional module within the access device.

Preferably, the data scheduling system accesses the first storage device, acquires parameter name of data in the first storage device, and transmits the same to the access device, and thus the access device receives the parameter name of data in the first storage device.

In the storage system, the data scheduling system acquires the parameter name of data in the first storage device by sending to the first storage device a get command, and transmits the parameter name of data in the first storage device to the access device by sending to the access device a move command.

step 203: the access device, according to the acquired parameter name, acquires data corresponding to the parameter name from the first storage device;

After acquiring the parameter name of data in the first storage device, the access device, according to the parameter name, sends to the first storage device a command for reading the data corresponding to the parameter name such that the first storage device, upon receipt of this command, transmit the date corresponding to the parameter name to the access device.

Preferably, the access device acquires the data corresponding to the parameter name by sending to the first storage device a get command that includes the parameter name.

The steps 202-203 characterize the procedure of the access device acquiring data in the first storage device, which being source storage device for the transferring.

step 204: the access device transfers the acquired data from the first storage device to the second storage device, the second storage device being a destination storage device for the transferring;

After acquiring the data in the first storage device, the access device transmits the data from the first storage device to the second storage device to implement data transferring, the second storage device being a destination storage device.

Preferably, the access device implements data transferring from the first storage device to the second storage device by sending to the second storage device a set command.

Further, when the access devices receives the service request, it performs corresponding operations to the first storage device and/or the second storage device according to the parameter name and the operation method of the object to be accessed. With the data transferring method described above, it is described in an embodiment by taking an example of the first storage device having higher priority than the second storage device.

step 205: when the access device receives the service request during the data transferring, it determines the operation method carried in the service request;

During the data transferring, the access device is responsible for service of the storage system for outside. When the access device receives the service request, it determines the operation method carried in the service request and performs corresponding operations according to the operation method.

Spherically, if the operation method indicates a writing operation, the step 206 is performed; if the operation method indicates a reading operation, the step 207 is performed; and if the operation method indicates a deleting operation, the step 212 is performed.

step 206: if the operation method carried in the service request indicates a writing operation, the access device writes data carried in the service request to the first storage device, and then the step 216 is performed.

It should be noted that if the storage devices have priority levels, access of data therein also has a certain priority level. By assigning priorities to the storage devices, process efficiency can be improved. According to an embodiment, a method for storing data in storage devices having levels of priorities is provided as below. Within such storage system, during data transferring, it is always that a storage device having lower priority acquires data from a storage device having higher priority. Thus, the data contained in each level of storage device has a time gradient, which reflects condition of access time. The data for which access frequency is higher or access interval is shorter is stored in a storage device having higher priority in order for convenience access by a user, while the data for which access frequency is lower or access interval is longer is stored in a storage device having lower priority in order for shorten access time required for the user.

When the access device receives the service request, if the operation method carried in the service request indicates a writing operation, the service operation must further carry data of the object to be accessed. If the first storage device has higher priority than the second storage priority, the access device preferably writes the parameter name and the data of the object to be accessed carried in the service request to the first storage device.

step 207: if the operation method carried in the service request indicates a reading operation, the access device determines whether the first storage device has data correspond to the parameter name of the object to be accessed carried in the service request or not, and if yes, the step 208 is then performed; if no, the step 209 is then performed;

When the access device receives the service request during the data transferring, if the operation method carried in the service request indicates a reading operation and if the first storage device has higher priority than the second storage priority, the access device sends to the first storage device a message including the parameter name of the object to be accessed carried in the service request such that the first storage device, upon receipt of the message, does matching with parameter name of data stored in the first storage device. If data corresponding to the parameter name of the object to be accessed is found based on the matching, the first storage device sends to the access device a successful matching message containing data matched with the parameter name of the object to be accessed. Upon receiving such successful matching message, the access device determines whether the first storage device has data corresponding the parameter name of the object to be accessed, and if there is no data matched with the parameter name of the object to be accessed in the first storage device, the first storage device sends to the access device a failed matching message, and upon receiving such failed matching message, the access device makes a determination that there is no data matched with the parameter name of the object to be accessed in the first storage device.

step 208: if there is the data corresponding to the parameter name of the object to be accessed carried in the service request in the first storage device, the access device reads the data corresponding to the parameter name of the object to be accessed, and then the step 216 is performed;

If there is the data corresponding to the parameter name of the object to be accessed carried in the service request in the first storage device, the successful matching message received by the access device carries the data corresponding to the parameter name of the object to be accessed, and then the access device reads the data corresponding to the parameter name of the object to be accessed. Then, the access device transmits the data to the user for acquirement of the data by the user.

step 209: if there is no the data corresponding to the parameter name of the object to be accessed carried in the service request in the first storage device, the access device determines whether there is the data corresponding to the parameter name of the object to be accessed carried in the service request in the second storage device, and if yes, the step 210 is then performed; if no, the step 211 then is performed.

In the case that the access device does not find the data corresponding to the parameter name of the object to be accessed in the first storage device, it, according to the data storage method described in the step 206, gets to know that amount of the data being accessed is smaller and thus the data may be stored in another storage device other than the first storage device.

The access device sends to the second storage device a message including the parameter name of the object to be accessed such that the second storage device, upon receipt of the message, does matching with parameter name of data stored in the second storage device. If data corresponding to the parameter name of the object to be accessed is found based on the matching, the second storage device sends to the access device a successful matching message containing data matched with the parameter name of the object to be accessed. Upon receiving such successful matching message, the access device determines that there is the data corresponding to the parameter name of the object to be accessed in the second storage device. If the data corresponding to the parameter name of the object to be accessed is found in the second storage device, the second storage device sends to the access device a failed matching message, and upon receiving such failed matching message, the access device makes a determination that there is no data corresponding to the parameter name of the object to be accessed carried in the service request in the second storage device.

step 210: if there is the data corresponding to the parameter name of the object to be accessed carried in the service request in the second storage device, the access device reads the data corresponding to the parameter name of the object to be accessed carried in the service request, and then the step 216 is performed;

Specifically, if there is the data corresponding to the parameter name of the object to be accessed carried in the service request in the second storage device, the successful matching message received by the access device carries the data corresponding to the parameter name of the object to be accessed carried in the service request, and then the access device reads the data corresponding to the parameter name of the object to be accessed carried in the service request. Then, the access device transmits the data to the user for acquirement of the data by the user.

step 211: According to the parameter name of the object to be accessed carried in the service request, matching is done in other storage devices until the data corresponding to the parameter name of the object to be accessed carried in the service request is found, and then the step 216 is performed;

The step 211 is an optional step. When the storage system includes more than three levels of storage devices, if the access device fails to find the data corresponding to the parameter name of the object to be accessed carried in the service request in the first and second storage devices, then it, according to parameter name of the object to be accessed carried in the service request, does matching in other storage devices within the storage system. The procedure of such matching is similar to that described in step 208 and thus is omitted.

The steps 207-211 involve the procedure that the access device reads the data corresponding to the parameter name of the object to be accessed carried in the service request in the first and second storage devices.

step 212: if the operation method carried in the service request indicates a deleting operation, the access device determines whether the second storage device has the data corresponding to the parameter name of the object to be accessed carried in the service request or not, and if yes, the step 213 is then performed; if no, the step 214 is then performed;

In order to avoid the case where some data exists in the first and second storage devices at the same time due to data transferring or other reasons, the present embodiments, for the deleting operation, find the object to be accessed in a sequence from a storage device having lower priority to a storage device having higher priority based on priorities of these storage devices. When there is the data corresponding to the parameter name of the object to be accessed in any storage device being checked, the data corresponding to object to be accessed is deleted.

In the embodiments, if the operation method carried in the service request indicates a deleting operation, the access device transmits to the second storage device a message containing the parameter name of the object to be accessed carried in the service request and a deleting operation such that the second storage device, upon receive the message, does matching in the second storage device according to the parameter name contained in the message. If the data corresponding to the parameter name of the object to be accessed carried in the service request is found, it is determined that there is the data corresponding to the parameter name of the object to be accessed carried in the service request in the second storage device. If the data corresponding to the parameter name of the object to be accessed carried in the service request is not found in the second storage device, it is determined that there is no the data corresponding to the parameter name of the object to be accessed carried in the service request in the second storage device.

It should be noted that for the deleting operation, another deleting manner having a sequence from a storage device having higher priority to a storage device having lower priority may be used in another embodiment, and with this deleting manner, the data corresponding to the parameter name of the object to be accessed carried in the service request can be deleted from the storage system.

step 213: if there is the data corresponding to the parameter name of the object to be accessed carried in the service request in the second storage device, the data corresponding to the parameter name of the object to be accessed carried in the service request is deleted.

That is, if there is the data corresponding to the parameter name of the object to be accessed carried in the service request in the second storage device, the second storage device, according to the deleting operation indicated in the received message, deletes the data corresponding to the parameter name of the object to be accessed carried in the service request.

step 214: the access device determines whether there is the data corresponding to the parameter name of the object to be accessed carried in the service request in the first storage device, and if yes, the step 215 is then performed; if no, the step 216 then is performed;

This procedure that the access device determines whether there is the data corresponding to the parameter name of the object to be accessed carried in the service request in the first storage device is similar to that described in the step 213 and thus description thereof is omitted.

Step 215: if there is the data corresponding to the parameter name of the object to be accessed carried in the service request in the first storage device, the data corresponding to the parameter name of the object to be accessed carried in the service request is deleted, and then the step 216 is performed;

That is, if there is the data corresponding to the parameter name of the object to be accessed carried in the service request in the first storage device, the first storage device, according to the deleting operation indicated in the received message, deletes the data corresponding to the parameter name of the object to be accessed carried in the service request.

The steps 212-215 involve the procedure that the access device deletes the data corresponding to the parameter name of the object to be accessed carried in the service request in the first and second storage devices when the operation method carried in the service request indication a deleting operation.

The steps 205-215 involve the procedure that the access device, upon receipt of a service request during data transferring, the service request containing at least parameter name and operation method of an object to be accessed, performs corresponding operations to the first storage device and/or the second storage devices according to the parameter name and the operation method of the object to be accessed.

step 216: the access device transmits to the first storage device a transferring completing command, and thus the procedure of transferring is terminated.

In the embodiments, as described above, the storage device may be a hot storage device or a cold storage device. Accordingly, when the first storage device receives the transferring completing command, the following steps may be performed depending on the relationship between the first and second storage devices: when the first storage device is a hot storage device and the second storage device is a cold storage device, the access device transmits to the first storage device a transferring completing command such that the first storage device, upon receipt of the transferring completing command, deletes the data that has been transferred from the first storage device and reduces its capacitance. That is, after the transferring, the hot storage device deletes the data that has been transferred and reduces its capacitance, and thereby storage space may be recovered.

In another hand, Accordingly, when the first storage device receives the transferring completing command, the following steps may be performed depending on the relationship between the first and second storage devices: when the first storage device is a cold storage device and the second storage device is a hot storage device, the access device transmits to the first storage device a transferring completing command such that the first storage device, upon receipt of the transferring completing command, stops operations. That is, after the transferring, the cold storage device stops operation such that the cold storage device may be moved out from the storage system.

With the data transferring method in which acquiring, by an access device, data of a first storage device; transferring, by the access device, the acquired data of the first storage device to a second storage device; performing, by the access device upon receiving a service request during transferring of the data, the service request carrying at least parameter name and operation method of an object to be accessed, corresponding service operations on the first storage device and/or the second storage device according to the parameter name and the operation method of the object to be accessed, data transferring between the first storage device and the second storage device and normal processing of service for outside is achieved through the access device, and thereby step of adding underlayer protocols for achieving access between storage devices is not needed and problem of requiring multiple developments because need of consideration of different types of protocols between storage devices when a third-party tool conducts the data transferring can be avoided, and thereby cost for data transferring can be reduced and complexity of system also can be reduced.

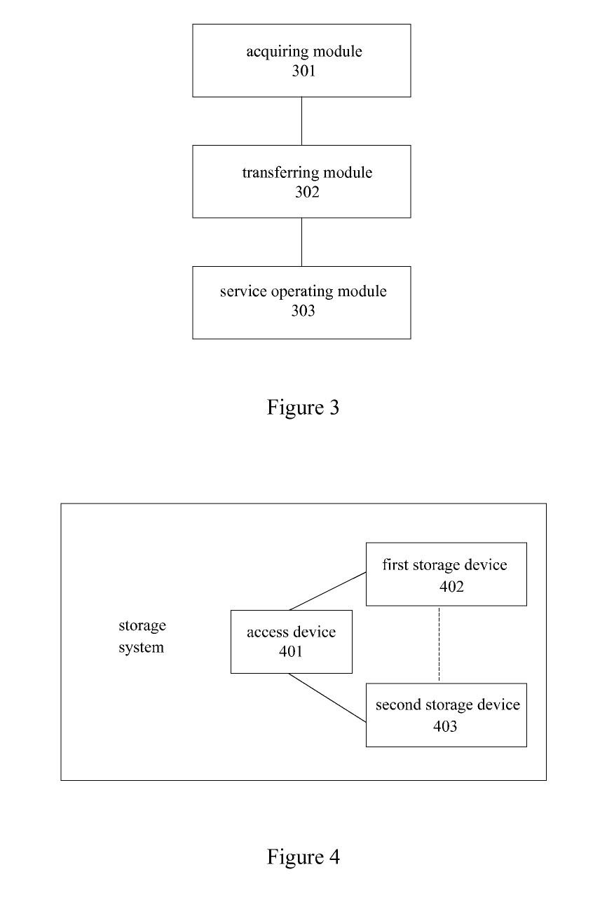

FIG. 3 is a figure illustrating structure of a data transferring apparatus according to an embodiment of the present invention. As shown in FIG. 3, the data transferring apparatus includes:

an acquiring module 301 configured to acquire data of the first storage device, the first storage device being source storage device for transferring;

a transferring module 302 configured to transfer the acquired data of the first storage device to the second storage device, the second storage device being destination storage device for the transferring; and

a service operating module 303 configured to perform, upon receiving a service request during transferring of the data, the service request carrying at least parameter name and operation method of an object to be accessed, corresponding service operations on the first storage device and/or the second storage device according to the parameter name and the operation method of the object to be accessed.

The acquiring module 301 includes:

a parameter name acquiring unit configured to acquire a parameter name of data of the first storage device; and

a data acquiring unit configured to, according to the acquired parameter name, acquire the data corresponding to the parameter name from the first storage device.

The service operating module 303 includes:

a write operating unit configured to, if the operation method carried in the service request is a write operation, write data carried in the service request to the first storage device;

a read operating unit configured to, if the operation method carried in the service request is a read operation, read data from the first storage device or the second storage device that corresponds to the parameter name of the object to be accessed carried in the service request; and

a delete operating unit configured to, if the operation method carried in the service request is a delete operation, delete data from the first storage device and the second storage device that corresponds to the parameter name of the object to be accessed carried in the service request.

The read operating unit includes:

a first determining subunit configured to determine whether the first storage device has the data that corresponds to the parameter name of the object to be accessed carried in the service request;

a reading subunit configured to, if there is the data that corresponds to the parameter name of the object to be accessed carried in the service request in the first storage device, read the data that corresponds to the parameter name of the object to be accessed carried in the service request from the first storage device; and

the first determining subunit further is configured to, if there is not the data that corresponds to the parameter name of the object to be accessed carried in the service request in the first storage device, determine whether the second storage device has the data that corresponds to the parameter name of the object to be accessed carried in the service request; and

the reading subunit further is configured to, if there is the data that corresponds to the parameter name of the object to be accessed carried in the service request in the second storage device, reading the data that corresponds to the parameter name of the object to be accessed carried in the service request from the second storage device.

The delete operating unit includes:

a second determining subunit configured to determine whether the second storage device has the data that corresponds to the parameter name of the object to be accessed carried in the service request;

a deleting subunit configured to, if there is the data that corresponds to the parameter name of the object to be accessed carried in the service request in the second storage device, delete the data that corresponds to the parameter name of the object to be accessed carried in the service request from the second storage device; and

the second determining subunit further is configured to determine whether the first storage device has the data that corresponds to the parameter name of the object to be accessed carried in the service request; and

the deleting subunit further is configured to, if there is the data that corresponds to the parameter name of the object to be accessed carried in the service request in the first storage device, delete the data that corresponds to the parameter name of the object to be accessed carried in the service request from the first storage device.

The apparatus further includes:

a receiving module 305 configured to receive a service request for data in the first storage device that is sent from the first storage device; or, receive a service request for data in the second storage device that is sent from the second storage device.

The apparatus further includes:

a sending module 305 configured to, if the first storage device is a hot storage device and the second storage device is a cold storage device, send a transferring complete command to the first storage device such that the first storage device, upon receiving the transferring complete command, deletes data that has been transferred therefrom and reduces its capacitance; and if the first storage device is a cold storage device and the second storage device is a hot storage device, send a transferring complete command to the first storage device such that the first storage device, upon receiving the transferring complete command, stops its operation.

With the data transferring apparatus in which acquiring, by an access device, data of a first storage device; transferring, by the access device, the acquired data of the first storage device to a second storage device; performing, by the access device upon receiving a service request during transferring of the data, the service request carrying at least parameter name and operation method of an object to be accessed, corresponding service operations on the first storage device and/or the second storage device according to the parameter name and the operation method of the object to be accessed, data transferring between the first storage device and the second storage device and normal processing of service for outside is achieved through the access device, and thereby step of adding underlayer protocols for achieving access between storage devices is not needed and problem of requiring multiple developments because need of consideration of different types of protocols between storage devices when a third-party tool conducts the data transferring can be avoided, and thereby cost for data transferring can be reduced and complexity of system also can be reduced.

Please note that the data transferring apparatus is described with the above mentioned modules by way of examples. In practical application, these functions may be divided in a different manner, that is, the internal structure of the apparatus may be divided into different functional modules for performing all or parts of the functions. Moreover, the data transferring apparatus comes from the same idea as the data transferring method described above, so its operating procedure is the same as that of the method and thus is omitted.

FIG. 4 is a figure illustrating structure of a storage system according to an embodiment of the present invention. As shown in FIG. 4, the storage system includes:

an access device 401 and at least storage devices, the at least storage devices including a first storage device 402 and a second storage device 403,

wherein the access device 401 is configured to:

acquiring, by the access device 401, data of the first storage device 402, the first storage device 402 being source storage device for transferring;

transferring, by the access device 401, the acquired data of the first storage device 402 to the second storage device 403, the second storage device 403 being destination storage device for the transferring; and

performing, by the access device 401 upon receiving a service request during transferring of the data, the service request carrying at least parameter name and operation method of an object to be accessed, corresponding service operations on the first storage device 402 and/or the second storage device 403 according to the parameter name and the operation method of the object to be accessed.

With the storage system as described above, in an implementation of the present embodiment, said acquiring includes:

acquiring, by the access device 401, a parameter name of data of the first storage device 402; and

according to the acquired parameter name, acquiring, by the access device 401, the data corresponding to the parameter name from the first storage device 402.

With the storage system as described above, in another implementation of the present embodiment, said performing includes:

if the operation method carried in the service request is a write operation, writing, by the access device 401, data carried in the service request to the first storage device 402;

if the operation method carried in the service request is a read operation, reading, by the access device 401, data from the first storage device 402 or the second storage device 403 that corresponds to the parameter name of the object to be accessed carried in the service request; and

if the operation method carried in the service request is a delete operation, deleting, by the access device 401, data from the first storage device 402 and the second storage device 403 that corresponds to the parameter name of the object to be accessed carried in the service request.

With the storage system as described above, in another implementation of the present embodiment, said reading includes:

determining, by the access device 401, whether the first storage device 402 has the data that corresponds to the parameter name of the object to be accessed carried in the service request;

if there is the data that corresponds to the parameter name of the object to be accessed carried in the service request in the first storage device 402, reading, by the access device 401, the data that corresponds to the parameter name of the object to be accessed carried in the service request from the first storage device; and

if there is not the data that corresponds to the parameter name of the object to be accessed carried in the service request in the first storage device 402, determining, by the access device 401, whether the second storage device 403 has the data that corresponds to the parameter name of the object to be accessed carried in the service request; and

if there is the data that corresponds to the parameter name of the object to be accessed carried in the service request in the second storage device 403, reading, by the access device 401, the data that corresponds to the parameter name of the object to be accessed carried in the service request from the second storage device 403.

With the storage system as described above, in another implementation of the present embodiment, said deleting includes:

determining, by the access device 401, whether the second storage device 403 has the data that corresponds to the parameter name of the object to be accessed carried in the service request;

if there is the data that corresponds to the parameter name of the object to be accessed carried in the service request in the second storage device 403, deleting, by the access device 401, the data that corresponds to the parameter name of the object to be accessed carried in the service request from the second storage device 403; and

determining, by the access device 401, whether the first storage device 402 has the data that corresponds to the parameter name of the object to be accessed carried in the service request; and

if there is the data that corresponds to the parameter name of the object to be accessed carried in the service request in the first storage device 402, deleting, by the access device 401, the data that corresponds to the parameter name of the object to be accessed carried in the service request from the first storage device 402.

With the storage system as described above, in another implementation of the present embodiment, before said performing, the method further includes:

receiving, by the access device 401, a service request for data in the first storage device that is sent from the first storage device 402; or

receiving, by the access device 401, a service request for data in the second storage device that is sent from the second storage device 403.

With the storage system as described above, in another implementation of the present embodiment, after said transferring, the method further includes:

if the first storage device 402 is a hot storage device and the second storage device 403 is a cold storage device, sending, by the access device 401, a transferring complete command to the first storage device 402 such that the first storage device 402, upon receiving the transferring complete command, deletes data that has been transferred therefrom and reduces its capacitance; and

if the first storage device 402 is a cold storage device and the second storage device 403 is a hot storage device, sending, by the access device 401, a transferring complete command to the first storage device 402 such that the first storage device 402, upon receiving the transferring complete command, stops its operation.

With the data storage system in which acquiring, by an access device, data of a first storage device; transferring, by the access device, the acquired data of the first storage device to a second storage device; performing, by the access device upon receiving a service request during transferring of the data, the service request carrying at least parameter name and operation method of an object to be accessed, corresponding service operations on the first storage device and/or the second storage device according to the parameter name and the operation method of the object to be accessed, data transferring between the first storage device and the second storage device and normal processing of service for outside is achieved through the access device, and thereby step of adding underlayer protocols for achieving access between storage devices is not needed and problem of requiring multiple developments because need of consideration of different types of protocols between storage devices when a third-party tool conducts the data transferring can be avoided, and thereby cost for data transferring can be reduced and complexity of system also can be reduced.

A person skilled in the art should understand that all or a part of steps in the embodiments can be implemented through hardwares or through a program that instruct hardwares to do operations, the program may be stored on a computer readable storage medium that can be ROM, magnetic disk or optical disk and the like.

The above descriptions show only optimal embodiments of the present invention and are not intended to limit the present invention. Any modification, alternation and variations made within the spirit of the present invention, falls within the scope to be claimed.

What is claimed is:

1. A data transferring method, wherein the method is performed in a data storage system which comprises an access device and at least two storage devices, the at least two storage devices including a first storage device and a second storage device, the method comprising:
acquiring, by the access device, data of the first storage device, the first storage device being source storage device for transferring;
transferring, by the access device, the acquired data of the first storage device to the second storage device, the second storage device being destination storage device for the transferring; and
performing, by the access device upon receiving a service request during transferring of the data, the service request carrying at least parameter name and operation method of an object to be accessed, corresponding service operations on the first storage device and/or the second storage device according to the parameter name and the operation method of the object to be accessed.

2. The data transferring method according to claim 1, wherein said acquiring comprises:
acquiring, by the access device, a parameter name of data of the first storage device; and
acquiring, by the access device, the data corresponding to the parameter name from the first storage device according to the acquired parameter name.

3. The data transferring method according to claim 1, wherein said performing comprises:
if the operation method carried in the service request is a write operation, writing, by the access device, data carried in the service request to the first storage device;
if the operation method carried in the service request is a read operation, reading, by the access device, data from the first storage device or the second storage device that corresponds to the parameter name of the object to be accessed carried in the service request; and
if the operation method carried in the service request is a delete operation, deleting, by the access device, data from the first storage device and the second storage device that corresponds to the parameter name of the object to be accessed carried in the service request.

4. The data transferring method according to claim 3, wherein said reading comprises:
determining, by the access device, whether the first storage device has the data that corresponds to the parameter name of the object to be accessed carried in the service request;
if there is the data that corresponds to the parameter name of the object to be accessed carried in the service request in the first storage device, reading, by the access device, the data that corresponds to the parameter name of the object to be accessed carried in the service request from the first storage device; and
if there is not the data that corresponds to the parameter name of the object to be accessed carried in the service request in the first storage device, determining, by the access device, whether the second storage device has the data that corresponds to the parameter name of the object to be accessed carried in the service request; and
if there is the data that corresponds to the parameter name of the object to be accessed carried in the service request in the second storage device, reading, by the access device, the data that corresponds to the parameter name of the object to be accessed carried in the service request from the second storage device.

5. The data transferring method according to claim 3, wherein said deleting comprises:
determining, by the access device, whether the second storage device has the data that corresponds to the parameter name of the object to be accessed carried in the service request;
if there is the data that corresponds to the parameter name of the object to be accessed carried in the service request in the second storage device, deleting, by the access device, the data that corresponds to the parameter name of the object to be accessed carried in the service request from the second storage device; and
determining, by the access device, whether the first storage device has the data that corresponds to the parameter name of the object to be accessed carried in the service request; and
if there is the data that corresponds to the parameter name of the object to be accessed carried in the service request in the first storage device, deleting, by the access device, the data that corresponds to the parameter name of the object to be accessed carried in the service request from the first storage device.

6. The data transferring method according to claim 3, wherein before said performing, the method further comprises:
receiving, by the access device, a service request for data in the first storage device that is sent from the first storage device; or
receiving, by the access device, a service request for data in the second storage device that is sent from the second storage device.

7. The data transferring method according to claim 1, wherein after said transferring, the method further comprises:
if the first storage device is a hot storage device and the second storage device is a cold storage device, sending, by the access device, a transferring complete command to the first storage device such that the first storage device, upon receiving the transferring complete command, deletes data that has been transferred therefrom and reduces its capacitance; and
if the first storage device is a cold storage device and the second storage device is a hot storage device, sending, by the access device, a transferring complete command to the first storage device such that the first storage device, upon receiving the transferring complete command, stops its operation.

8. A data transferring apparatus comprises:
an acquiring module configured to acquire data of the first storage device, the first storage device being source storage device for transferring;
a transferring module configured to transfer the acquired data of the first storage device to the second storage device, the second storage device being destination storage device for the transferring; and
a service operating module configured to perform, upon receiving a service request during transferring of the data, the service request carrying at least parameter name and operation method of an object to be accessed, corresponding service operations on the first storage device and/or the second storage device according to the parameter name and the operation method of the object to be accessed.

9. The data transferring apparatus according to claim 8, wherein said acquiring module comprises:
a parameter name acquiring unit configured to acquire a parameter name of data of the first storage device; and
a data acquiring unit configured to acquire the data corresponding to the parameter name from the first storage device according to the acquired parameter name.

10. The data transferring apparatus according to claim 8, wherein said service operating module further comprises:
a write operating unit configured to, if the operation method carried in the service request is a write operation, write data carried in the service request to the first storage device;
a read operating unit configured to, if the operation method carried in the service request is a read operation, read data from the first storage device or the second storage device that corresponds to the parameter name of the object to be accessed carried in the service request; and
a delete operating unit configured to, if the operation method carried in the service request is a delete operation, delete data from the first storage device and the second storage device that corresponds to the parameter name of the object to be accessed carried in the service request.

11. The data transferring apparatus according to claim 10, wherein said read operating unit further comprises:
a first determining subunit configured to determine whether the first storage device has the data that corresponds to the parameter name of the object to be accessed carried in the service request;
a reading subunit configured to, if there is the data that corresponds to the parameter name of the object to be accessed carried in the service request in the first storage device, read the data that corresponds to the parameter name of the object to be accessed carried in the service request from the first storage device; and
the first determining subunit further is configured to, if there is not the data that corresponds to the parameter name of the object to be accessed carried in the service request in the first storage device, determine whether the second storage device has the data that corresponds to the parameter name of the object to be accessed carried in the service request; and
the reading subunit further is configured to, if there is the data that corresponds to the parameter name of the object to be accessed carried in the service request in the second storage device, reading the data that corresponds to the parameter name of the object to be accessed carried in the service request from the second storage device.

12. The data transferring apparatus according to claim 10, wherein said delete operating unit further comprises:
a second determining subunit configured to determine whether the second storage device has the data that corresponds to the parameter name of the object to be accessed carried in the service request;
a deleting subunit configured to, if there is the data that corresponds to the parameter name of the object to be accessed carried in the service request in the second storage device, delete the data that corresponds to the parameter name of the object to be accessed carried in the service request from the second storage device; and
the second determining subunit further is configured to determine whether the first storage device has the data that corresponds to the parameter name of the object to be accessed carried in the service request; and
the deleting subunit further is configured to, if there is the data that corresponds to the parameter name of the object to be accessed carried in the service request in the first storage device, delete the data that corresponds to the parameter name of the object to be accessed carried in the service request from the first storage device.

13. The data transferring apparatus according to claim 8, wherein the apparatus further comprises:
a receiving module configured to receive a service request for data in the first storage device that is sent from the first storage device; or, receive a service request for data in the second storage device that is sent from the second storage device.

14. The data transferring apparatus according to claim 8, wherein the apparatus further comprises:
a sending module configured to, if the first storage device is a hot storage device and the second storage device is a cold storage device, send a transferring complete command to the first storage device such that the first storage device, upon receiving the transferring complete command, deletes data that has been transferred therefrom and reduces its capacitance; and if the first storage device is a cold storage device and the second storage device is a hot storage device, send a transferring complete command to the first storage device such that the first storage device, upon receiving the transferring complete command, stops its operation.

15. A storage system, wherein the storage system comprises an access device and at least storage devices, the at least storage devices including a first storage device and a second storage device, the access device is configured to:
acquiring, by the access device, data of the first storage device, the first storage device being source storage device for transferring;
transferring, by the access device, the acquired data of the first storage device to the second storage device, the second storage device being destination storage device for the transferring; and
performing, by the access device upon receiving a service request during transferring of the data, the service request carrying at least parameter name and operation method of an object to be accessed, corresponding service operations on the first storage device and/or the second storage device according to the parameter name and the operation method of the object to be accessed.

16. A computer readable storage medium storing computer executable instructions for controlling a computer to execute the data transferring method as claimed in claim 1.
